(19) United States
(12) Patent Application Publication
(10) Pub. No.: US 2025/0315959 A1
(43) Pub. Date: Oct. 9, 2025

(54) RECURSIVE OBJECT DETECTION FILTER

(71) Applicant: NORTHROP GRUMMAN SYSTEMS CORPORATION, FALLS CHURCH, VA (US)

(72) Inventor: BENJAMIN E.K. SUGERMAN, Pikesville, MD (US)

(21) Appl. No.: 18/627,700

(22) Filed: Apr. 5, 2024

(51) Int. Cl. G06T 7/246

(52) U.S. Cl. CPC G06T 7/246; G06T 2207/10044; G06T 2207/20076

(57) ABSTRACT

Systems and methods are provided for detecting and tracking objects. A first set of observations for a plurality of locations includes a probability that a value associated with the location is consistent with local background. A second set of observations includes a probability that the value associated with the location is not consistent with local background. A first probability tensor representing probabilities for each of a plurality of states for each of the plurality of locations is generated from the first and second sets of observations. The first probability tensor is updated according to a second probability tensor representing the probabilities for each of the plurality of states in a previous time step. It is determined that a target is present in the region of interest when a posterior probability meets a threshold value.

### TECHNICAL FIELD

The present invention relates to target detection and tracking in imaging systems, and more particularly, to a recursive object detection filter.

### BACKGROUND

Track Before Detect is a method to detect faint signals in a time series of discretized data, such as two-dimensional images or one-dimensional SONAR arrays and provide an associated state estimate at the same time a detection is declared. By establishing an initial estimate of a target's state, for example, its position and velocity, Track Before Detect provides rejection criteria for many detections in cluttered environments, such as rejecting stationary targets on the ground if observing moving airborne targets. Current practice for Track Before Detect has a number of implementation challenges that are handled through various “safe math” functions and ad-hoc assumptions. This requires extensive and application-specific tuning and ensures continued fragility to numerous failure modes. The failure modes are not necessarily exotic edge cases, and as just one example, many implementations of Track Before Detect will fail if a bright target enters the field of view.

### SUMMARY OF THE INVENTION

In one aspect of the present invention, a method includes receiving a first set of observations for the region of interest comprising, for each of a plurality of locations, a probability that a value associated with the location is consistent with a local background of the location and a second set of observations comprising, for each of the plurality of locations, a probability that the value associated with the location is not consistent with the local background of the location. A first probability tensor representing probabilities for each of a plurality of states for each of the plurality of locations is generated from the first set of observations and the second set of observations, a first state of the plurality of states representing the presence of a target at a location moving at a velocity within a range of velocities, and a second state of the plurality of states representing a state in which no target is present. The first probability tensor is updated according to a second probability tensor representing the probabilities for each of the plurality of states for each of the plurality of locations before receiving the first set of observations and the second set of observations to provide a posterior probability tensor representing probabilities for each of the plurality of states for each of the plurality of locations. It is determined that a target is present in the region of interest when the posterior probability associated with one of the plurality of states at one of the plurality of locations meets a threshold value.

In another aspect of the present invention, a system includes a processor and a non-transitory computer readable medium storing machine-readable instructions executable by the processor to provide an observation interface that receives a first set of observations for the region of interest comprising, for each of a plurality of locations, a probability that a value associated with the location is consistent with a local background of the location and a second set of observations comprising, for each of the plurality of locations, a probability that the value associated with the location is not consistent with a local background of the location. A recursive filter detects and tracks objects within the region of interest. The recursive filter includes a prediction component that generates a first probability tensor representing probabilities for each of a plurality of states for each of a plurality of locations associated with a region of interest from the first set of observations and the second set of observations. A first state of the plurality of states represents the presence of a target at a location moving at a velocity within a range of velocities, and a second state of the plurality of states representing a state in which no target is present. A filtering component updates the first probability tensor according to a second probability tensor representing the probabilities for each of the plurality of states for each of the plurality of locations before receiving the first set of observations and the second set of observations to provide a posterior probability tensor representing probabilities for each of the plurality of states for each of the plurality of locations. A detection component determines that a target is present in the region of interest when the posterior probability associated with one of the plurality of states at one of the plurality of locations meets a threshold value.

In a further aspect of the present invention, a method includes receiving an image of a region of interest comprising a plurality of pixels and generating, from the image of the region of interest, a first set of observations for the region of interest comprising, for each of the plurality of pixels, a probability that a value of the pixel is consistent with a local background of the pixel and a second set of observations comprising, for each of the plurality of pixels, a probability that the value of the pixel is not consistent with a local background of the pixel. A first probability tensor is generated, representing probabilities for each of a plurality of states for each of a plurality of pixels associated with a region of interest from the first set of observations and the second set of observations. A first state of the plurality of states represents the presence of a target at a location moving at a velocity within a range of velocities, and a second state of the plurality of states representing a state in which no target is present. The first probability tensor is normalized such that, for each of the plurality of pixels within the region of interest, the sum of the probabilities across the plurality of states is equal to one. The first probability tensor is updated according to a second probability tensor representing the probabilities for each of the plurality of states for each of the plurality of pixels before receiving the first set of observations and the second set of observations to provide a posterior probability tensor representing probabilities for each of the plurality of states for each of the plurality of pixels. It is determined that a target is present in the region of interest when the posterior probability associated with one of the plurality of states at one of the plurality of pixels meets a threshold value.

### BRIEF DESCRIPTION OF THE DRAWINGS

FIG. 1 illustrates one example of a system for detecting and tracking objects from sets of observations representing a region of interest;

FIG. 2 illustrates another example of an object detection and tracking system;

FIG. 3 illustrates one example of a method for detecting and tracking objects;

FIG. 4 illustrates another example of a method for detecting and tracking objects; and

FIG. 5 is a schematic block diagram illustrating an example system of hardware components capable of implementing examples of the systems and methods disclosed herein.

### DETAILED DESCRIPTION

The systems and methods described herein automatically detect any signals in a time series of data and provide an associated state estimate at the same time each new detection is declared without the limitations of current implementations of Track Before Detect. By functioning purely in the probability domain, the systems and methods avoid the weaknesses and failure modes of the traditional track-before-detect methodology. In particular, the systems and methods described herein avoid the mathematical simplification of using recursive Bayesian filtering of likelihood ratios, allowing for more robust detection. This is particularly useful for detection in imaging systems with lower resolution or other limitations, such as radar, sonar, and cameras that produce highly pixelated images.

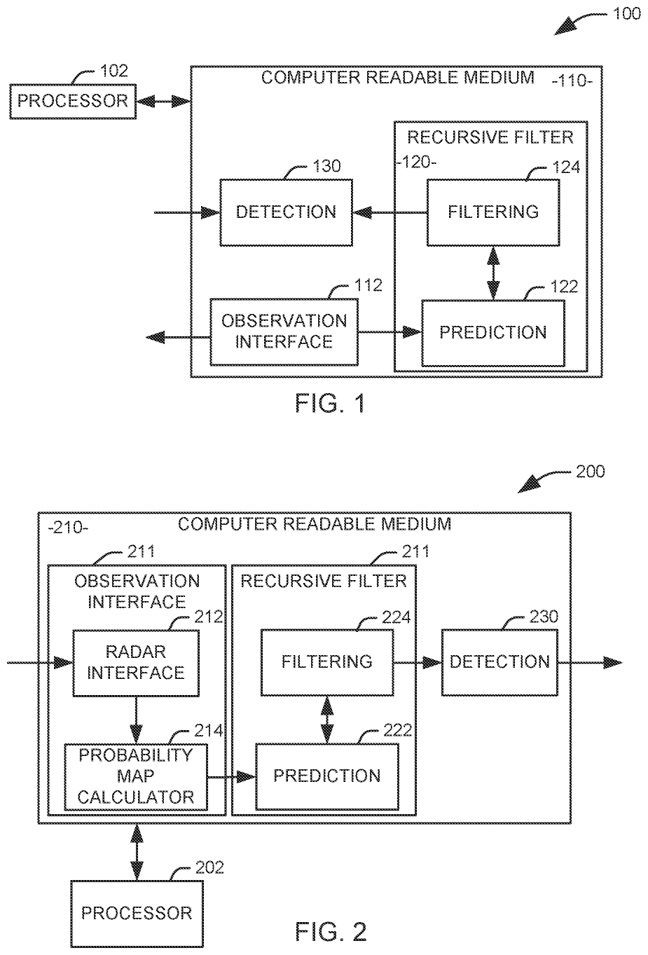

FIG. 1 illustrates one example of a system 100 for detecting and tracking objects from sets of observations representing a region of interest. The recursive filter system 100 includes a processor 102 and a non-transitory computer readable medium 110 that stores executable instructions for detecting and tracking objects with the region of interest. In the illustrated implementation, an observable interface 112 receives the observations as two probability maps for the region of interest, with a first probability map representing the probability for each of a plurality of locations that the received data for the location is consistent with the expected background statistics for the received data, and a second probability map representing the probability for each of the plurality of locations that the received data for the location is inconsistent with the expected background statistics, indicating that an object may be present. These probability maps are generated from a set of images taken at a sensor system, such as a radar system, a sonar system, or a camera detecting visible, infrared, or ultraviolet light. For radar images, the probability maps can be represented as two-dimensional arrays. From these probability maps, which serve as observations in the system 100, and an existing state of the system, the probability of an object at each of the plurality of locations can be estimated. As a recursive system, this is repeated for each successive time step to maintain consistent tracking and detection of objects within the region of interest.

In a detection task, observables (zₖ) to are used to estimate states (xₖ^{j}), where j∈{1,J} indicate J possible kinematic states, such as “a target exists and is at pixel (20,30) moving at velocity (2,1) pixels/sec. In the standard detection task, the observations are brightness values or return values. A set of observables, z, for given time step, k, is the set of all z(c, r) at pixel column and row (c, r) in the image. The system is augmented with the hidden state ϕₖ, meaning “there is no target present in any possible states given data zₜ.” The detection system attempts to measure p(z|x^{j}), the probability that a target in state xi is present and produces the observed signal z. In an image, a signal shows up at a discrete pixel z_{c,r}, or in some implementations, a region centered on that pixel. If a target's physical position in space projects to that image location at time k, then regardless of its other kinematics, such as velocity and acceleration, its signal z will be present at that position (c, r). Accordingly, p(z|x^{j})=p(z_{c,r}|s) expresses the probability that a target is present and produces a detectable signal of value z at pixel position (c, r). Similarly, p(z|ϕ)=p(z_{c,r}|b) expresses the probability that there is no target present at the projected image position (c, r), which is the same as the likelihood that the recorded pixel value z is just background. These probabilities are provided to a recursive filter 120 as observations, as opposed to the brightness values from the image. This allows the system 100 to avoid many of the failure modes of traditional Track Before Detect by operating entirely in probability space.

The recursive filter 120 includes a prediction component 122 that generates a first probability tensor representing probabilities for each of a plurality of states for each of a plurality of locations associated with a region of interest from the first set of observations and the second set of observations. A first set of kinematic states each represent the presence of a target at a location moving at a velocity within a range of velocities, and a hidden state represents a state in which no target is present. In one example, kinematic update matrices can be applied to the sets of observations to represent motion of targets within the region of interest, and the first probability tensor can be determined from the updated observations and a probability tensor representing a posterior probability from the previous time step. In one implementation, the prediction component normalizes the first probability tensor such that, for each of the plurality of locations within the region of interest, the sum of the probabilities across the plurality of states, including the hidden state, is equal to one.

A filtering component 124 updates the first probability tensor according to a second probability tensor representing the probabilities for each of the plurality of states for each of the plurality of locations given before receiving the first set of observations and the second set of observations to provide a posterior probability tensor representing probabilities for each of the plurality of states for each of the plurality of locations. The posterior probability tensor is provided to a detection component 130 that determines that a target is present in the region of interest when the posterior probability associated with one of the plurality of states at one of the plurality of locations meets a threshold value. In one example, the detection component determines that the target is present when the posterior probability associated with the first state at one of the plurality of locations is not less than a threshold value or the posterior probability at one of the plurality of locations associated with the second state is not greater than a threshold value. When a target is detected, an alert can be issued to a user with the position and kinematic state of the user at an associated display or other output device (not shown).

FIG. 2 illustrates another example of an object detection and tracking system 200. The object detection and tracking system 200 includes a processor 202 and a non-transitory computer readable medium 210 that stores executable instructions for detecting and tracking objects with the region of interest. The system 200 includes an observation interface 211 that receives radar data representing a region of interest from a radar system (not shown) and provides observations to a recursive filter 220. A radar interface 212 includes appropriate instructions for receiving and appropriately formatting the radar returns provided from the radar system. The radar interface 212 outputs, for each time step, an image representing the region of interest, with each pixel within the image having a value representing the magnitude of signal returned to the radar from a corresponding direction within the region of interest.

The image at each time step is provided to a probability map calculator 214. The probability map calculator 214 reviews the image to determine, for each pixel of a plurality of pixels comprising the image, a probability that the value of the pixel is consistent with the local background and a probability that the value of the pixel is not consistent with the location background. This can be accomplished through various means, with or without information about the expected appearance of a signal representing an object. In the illustrated implementation, the probabilities are determined using a Bayesian framework with an uninformative prior. The output of the probability map calculator is a first probability map comprising a probability for each location that the value of the pixel is consistent with the local background statistics, and a second probability map comprising a probability for each location that the value of the pixel is not consistent with the local background statistics.

The first and second probability maps are provided to the recursive filter 220, which detects and tracks objects within the region of interest based upon the probability maps provided from the probability map calculator 214 at each time step. It will be appreciated that the recursive filter 220 updates the positions and states of objects within the region of interest based on prior positions and states as well as new information from the probability map calculator 214, and thus the recursive filter will be initialized to provide state and position information for a first time step of the process. This can be a random assignment of states and targets within defined parameters, a first state in which all positions are in the no-target “hidden state”, or a defined default state for the system. Essentially, the recursive filter 220 determines probabilities that an object is present at each position in a kinematic state, xⱼ, of a plurality of defined kinematic states based on the previous probabilities, kinematic updating to shift the positions associated with the probabilities based upon the kinematics of the target, and new information provided by an image, zₖ. A probability of the appearance of a new target or disappearance of an existing target can be established as with a prior probability δ<<1, and a set of J states, X=x^{j}, j∈{1,J}, representing the kinematics of detected targets. Each pixel is its own discrete state that contains a range of positions. The states can represent discrete velocity bins that contain a range of speeds, e.g. vₓ⁰ is vₓ∈[−1,1] pix/s.

The recursive filter includes a prediction component 222 that determines an a priori probability for the current state of the system. More formally, the prediction component 222 determines tensors representing, for each location, the probability of the current state, xₖ, given the state preceding the current state, xₖ₋₁, and the observations, z_{1:k-1}, leading up to the current state, such that p(xₖ|z_{1:k-1})−p(xₖ|xₖ₋₁) p(xₖ₋₁|z_{1:k-1}). In the illustrated example, the prediction component 222 determines the probability tensor representing the probabilities across all locations and kinematic states that a location is in a state, j, of J states during at the current time, k, as:

$$p ( {x}_{k}^{j} \vert t ) = ( 1 - δ ) p ( {z}_{k} \vert s ) {T}_{k \vert k - 1} p ( {x}_{k}^{j} \vert {x}_{k - 1}^{j} ) p ( {x}_{k - 1}^{j} \vert k - 1 ) + δ \cdot p ( {z}_{k} \vert b ) {T}_{k \vert k - 1} p ( {ϕ}_{k} \vert k ) \qquad Eq . 1$$

where p(xₖ^{j}|xₖ₋₁^{j}) is a kinematic update matrix that represents an expected shift in position of a target given its kinematic state, T_{k|k-1} is a transition matrix that defines the likelihood that an object located in a given pixel will end up in a neighboring pixel based on the velocity resolution of the kinematic states, p(xₖ₋₁^{j}|k−1) is the probability tensor for the various kinematic states from the previous time step, δ is a probability of the appearance of a new target or disappearance of an existing target, p(zₖ|s) is the probability map representing the probability that the observation is inconsistent with expected background statistics, p(zₖ|b) is the probability map representing the probability that the observation is consistent with expected background statistics, and p(ϕₖ|k) is a matrix of probabilities that the each location is in the hidden state, representing the absence of a target, and is calculated as:

$$p ( {ϕ}_{k} \vert k ) = δ \cdot p ( {z}_{k} \vert s ) {\sum }_{j = 1}^{J} {T}_{k \vert k - 1} p ( {x}_{k}^{j} \vert {x}_{k - 1} ) p ( {x}_{k - 1}^{j} \vert k - 1 ) + ( 1 - δ ) p ( {z}_{k} \vert b ) {T}_{k \vert k - 1} p ( {ϕ}_{k - 1} \vert k - 1 ) \qquad Eq . 2$$

where p(ϕₖ₋₁|k−1) is a is the probability tensor for the hidden state from the previous time step.

In one example, a “smoothing” can be applied to the probability tensor of Eq. 1 as a small fraction, α, of the posterior state probabilities from the previous time step, such that a smoothed version of the probability tensor is calculated as:

$${p ( {x}_{k}^{j} \vert t )}_{smooth} = ( 1 - α ) p ( {x}_{k}^{j} \vert t ) + α p ( {x}_{k}^{j} \vert {x}_{k - 1}^{j} ) {p ( {x}_{k - 1}^{j} \vert k - 1 )}_{smooth} \qquad Eq . 3$$

where α is a tunable parameter that can vary between 0.01 and 0.05.

The kinematic update matrix, p(xₖ^{j}|xₖ₋₁^{j}), can be implemented according to the defined kinematic states of the system. In the illustrated example, the kinematic states are velocity states, and the system 200 assumes that the objects have either constant or slowly varying velocities. Accordingly, each kinematic state represents a range, or bin, of velocities. Each kinematic update matrix can be determined according to a center of the range of velocities as to apply a translation of the appropriate number of pixels to the probability tensor from the previous time step. For example, for a system having J=9 kinematic states, representing the nine possibilities of a velocity centered on one, zero, or negative one, in each of the horizontal and vertical directions, a kinematic state having a velocity range centered on a velocity of negative one pixel/second horizontally and negative one pixel/velocity vertically can be implemented as

$$p ( {x}_{k}^{j} \vert {x}_{k - 1}^{j} ) = [ \begin{matrix}1 & 0 & 0 \\ 0 & 0 & 0 \\ 0 & 0 & 0\end{matrix} ] .$$

It will be appreciated, however, that the velocity of the object in the image space is unlikely to be exactly equal to the center point of a given velocity range nor in the exact center of the region represented by a given image in the pixel. As a result, an object in a given state and at a given position may not project to the exact pixel in all cases. The transition matrix, T_{k|k-1}, encodes the likelihood that a target somewhere inside a pixel and with its given velocity range will end up in neighboring pixels after time step Δt. In one example, the transition matrix can be computed by a Monte Carlo simulation for a fixed time step at the initialization of the recursive filter and used through the tracking and detection process.

In another example, an analytic solution using the Tranini function can be used to generate the transition matrices. The Tranini function, t(x, Δv, Δt) provides an estimate that, if an object starts at a random point, x, within the area represented by a pixel and moves at a random velocity within a known velocity range, Δv, for a known time, Δt, how likely is it that the object ends up within a given pixel within the image space, and can be presented as:

$$p ( x , Δ v , Δ t ) = min [ \frac{1 + Δ t Δ v}{2 Δ t Δ v} ( 1 - \frac{2 \vert x \vert}{1 + Δ t Δ v} ) , \frac{2}{1 + Δ t Δ v} , 1 ] \qquad Eq . 4$$

The use of the Tranini function to generate the transition matrices allows the system to operate in real time with variable time steps. To handle variable time intervals, a recursive filter using a Monte Carlo simulation approach can either shift the data to the nearest multiple of the original time interval, which can cause exponential error growth, or recompute the Monte Carlo simulation, which is extremely time consuming. The Tranini function removes this limitation, allowing for new matrices to react to shifts in the time interval in real time for arbitrary velocity ranges. As part of the implementation of variable time steps, the recursive filter 220 can also perform non-integer pixel shifts.

It will be appreciated that, for each location, that a target is either present in one of the available states, or the location is in the hidden state, and thus the sum of the probabilities for all of the states at each location should equal one. Accordingly, the tensors shown in Eqs. 1 and 2 can be normalized, such that:

$${\sum }_{j = 1}^{J} p ( {x}_{k}^{j} \vert k ) + p ( {ϕ}_{k} \vert k ) = 1 \qquad Eq . 5$$

The tensors output from the prediction component 222 are provided to a filter component 224 that determines posterior probabilities for each state given all of the observations to date, including the current set of observations. For the target states, the posterior probabilities can be determined as:

$$p ( {x}_{k}^{j} \vert {z}_{1 : k} ) = p ( {x}_{k}^{j} \vert t ) p ( {x}_{k}^{j} \vert {z}_{1 : k - 1} ) \qquad Eq . 6$$

where p(xₖ^{j}|z_{1:k-1}) is a tensor representing the probabilities for each state given all previous observations and p(xₖ^{j}|t) is the tensor determined at the prediction component representing the probabilities for each state.

For the hidden state, the posterior probabilities can be determined as:

$$p ( {ϕ}_{k} \vert {z}_{1 : k} ) = p ( {ϕ}_{k} \vert k ) p ( {ϕ}_{k} \vert {z}_{1 : k - 1} ) \qquad Eq . 7$$

where p(ϕₖ|z_{1:k-1}) is a tensor representing the probabilities for the hidden state given all previous observations and p(ϕₖ|k) is the tensor determined at the prediction component representing the probabilities for the hidden state.

The posterior probability tensors can be provided to a detection component 230 that determines that a target is present in the region of interest when the posterior probability associated with one of the plurality of states at one of the plurality of locations meets a threshold value. In one example, the detection component determines that the target is present when the posterior probability associated with the first state at one of the plurality of locations is not less than a threshold value or the posterior probability at one of the plurality of locations associated with the second state is not greater than a threshold value. When a target is detected, an alert can be issued to a user with the position and kinematic state of the user at an associated display or other output device (not shown).

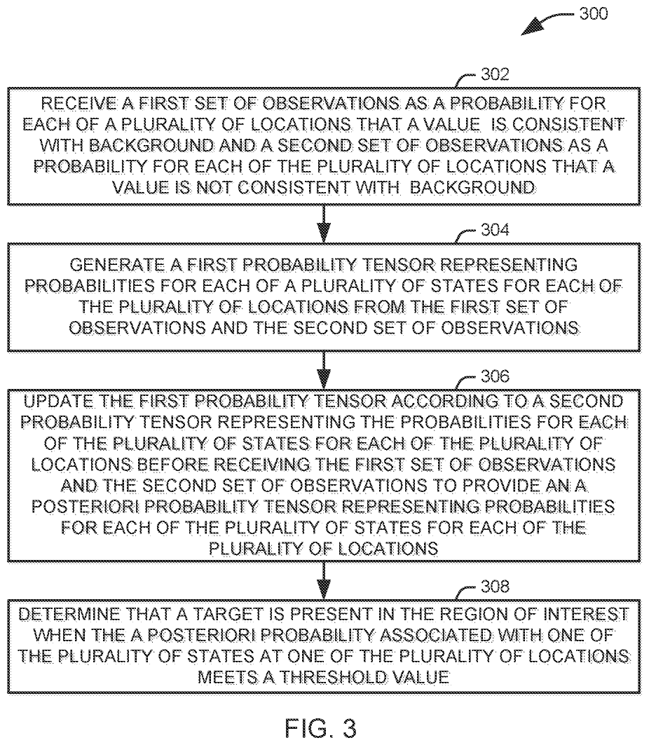

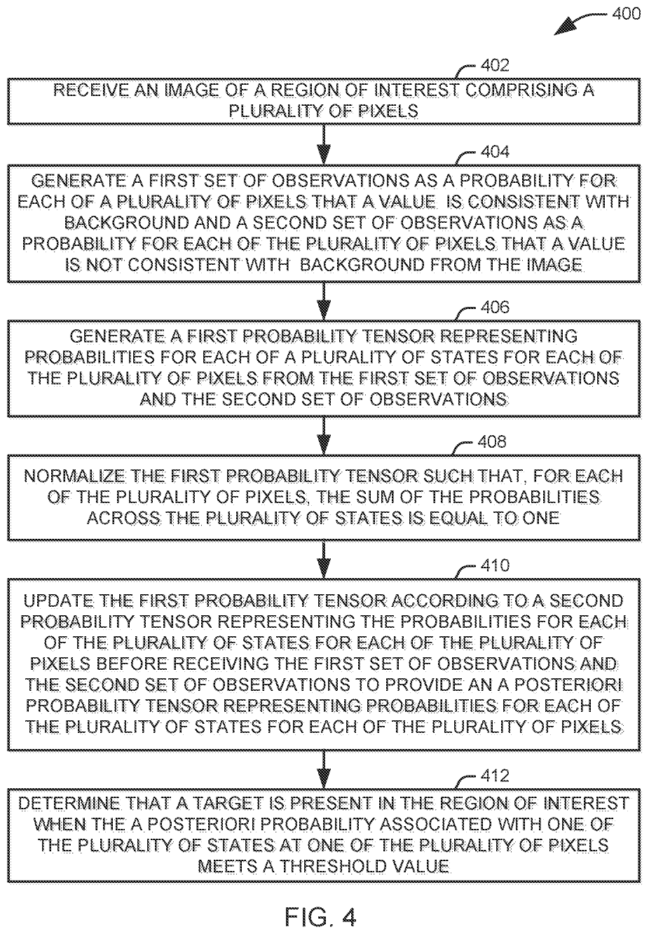

In view of the foregoing structural and functional features described above in FIGS. 1 and 2, example methods will be better appreciated with reference to FIGS. 3 and 4. While, for purposes of simplicity of explanation, the methods of FIGS. 3 and 4 are shown and described as executing serially, it is to be understood and appreciated that the present invention is not limited by the illustrated order, as some actions could in other examples occur in different orders and/or concurrently from that shown and described herein.

FIG. 3 illustrates one example of a method 300 for detecting and tracking objects. At 302, a first and second sets of observations for a region of interest are received. The first set of observations include, for each of a plurality of locations, a probability that a value associated with the location is consistent with a local background of the location. A second set of observations include, for each of the plurality of locations, a probability that the value associated with the location is not consistent with the local background of the location. In one implementation, the first set of observations and the second set of observations for the region of interest are generated by receiving an image of the region of interest, such as a radar, camera, or sonar image, and generating each of the first set of observations and the second set of observations from the image of the region of interest.

At 304, a first probability tensor representing probabilities for each of a plurality of states for each of the plurality of locations is generated from the first set of observations and the second set of observations. At least a first state of the plurality of states represents the presence of a target at a location moving at a velocity within a range of velocities, and a second, or hidden state, of the plurality of states represents a state in which no target is present. In one implementation, generating the first probability tensor includes applying at least one kinematic update matrix, each representing the motion of a target in a state associated with the kinematic update matrix, and a transition matrix that defines the likelihood that an object located in a given location of the plurality of locations will end up in a neighboring location of the plurality of locations based on a velocity resolution of the kinematic state, to each of the first set of observations and the second set of observations. The transition matrix can be generated analytically using the Tranini function described previously. In one example, the first probability tensor is normalized, such that, for each of the plurality of locations within the region of interest, the sum of the probabilities across the plurality of states is equal to one.

At 306, the first probability tensor is updated according to a second probability tensor representing the probabilities for each of the plurality of states for each of the plurality of locations before receiving the first set of observations and the second set of observations to provide a posterior probability tensor representing probabilities for each of the plurality of states for each of the plurality of locations. At 308, it is determined that a target is present in the region of interest when the posterior probability associated with one of the plurality of states at one of the plurality of locations meets a threshold value. In one example, it is determined that a target is present when the posterior probability associated with the first state at one of the plurality of locations is not less than a threshold value or the posterior probability at one of the plurality of locations associated with the second state is not greater than a threshold value. Upon detection of a target, a visible or audible alert may be presented to a user.

It will be appreciated that the method 300 can be used to implement a recursive filter, that thus the steps can be iteratively repeated for a plurality of iterations, each occurring at an associated one of a plurality of sequential time steps. At each iteration, a new set of observations for the region of interest can be received including, for each of the plurality of locations, a probability that a value associated with the location is consistent with a local background of the location and a probability that the value associated with the location is not consistent with a local background of the location. An initial probability tensor representing probabilities for each of the plurality of states for each of the plurality of locations from new set of observations can be generated for that time step and updated according to a posterior probability tensor from a previous time step to provide a posterior probability tensor for a current time step representing probabilities for each of the plurality of states for each of the plurality of locations. Detection occurs when the current posterior probability associated with one of the plurality of states at one of the plurality of locations meets the threshold value. It will be appreciated that the described method allows for variable intervals between iterations, such that an interval between a first time step of the plurality of sequential time steps and a second time step of the plurality of sequential time steps is different than an interval between the second time step of the plurality of sequential time steps and a third time step of the plurality of sequential time steps.

FIG. 4 illustrates another example of a method 400 for detecting and tracking objects. At 402, an image of a region of interest comprising a plurality of pixels is received. For example, the image can be a radar, sonar, or camera image taken from detecting visible, ultraviolet, or infrared light. At 404, each of a first set of observations and a second set of observations are generated, from the image of the region of interest. The first set of observations for the region of interest includes for each of the plurality of pixels, a probability that a value of the pixel is consistent with a local background of the pixel and the second set of observations include for each of the plurality of pixels, a probability that the value of the pixel is not consistent with a local background of the pixel.

At 406, a first probability tensor representing probabilities for each of a plurality of states for each of a plurality of pixels associated with a region of interest is generated from the first set of observations and the second set of observations. At least a first state of the plurality of states represents the presence of a target at a location moving at a velocity within a range of velocities, and a second state of the plurality of states represents a state in which no target is present. In one example, generating the first probability tensor comprises applying at least one kinematic update matrix, each representing the motion of a target in a state associated with the kinematic update matrix, and a transition matrix that defines the likelihood that an object located in a given pixel of the plurality of pixels will end up in a neighboring pixel of the plurality of pixels based on a velocity resolution of the kinematic state, to each of the first set of observations and the second set of observations. The transition matrix can be generated analytically using the Tranini function described previously.

At 408, the first probability tensor is normalized such that, for each of the plurality of pixels within the region of interest, the sum of the probabilities across the plurality of states is equal to one. At 410, the first probability tensor is updated according to a second probability tensor representing the probabilities for each of the plurality of states for each of the plurality of pixels given at least one set of before receiving the first set of observations and the second set of observations to provide a posterior probability tensor representing probabilities for each of the plurality of states for each of the plurality of pixels. At 412, it is determined that a target is present in the region of interest when the posterior probability associated with one of the plurality of states at one of the plurality of pixels meets a threshold value. In one example, it is determined that a target is present when the posterior probability associated with the first state at one of the plurality of pixels is not less than a threshold value or the posterior probability at one of the plurality of pixels associated with the second state is not greater than a threshold value. Upon detection of a target, a visible or audible alert may be presented to a user. It will be appreciated that the method can be repeated iteratively, with each iteration separated by an interval of time, and the time intervals can be variable, such that an interval of time between a first iteration and a second iteration is different that an interval of time between the second iteration and a third iteration.

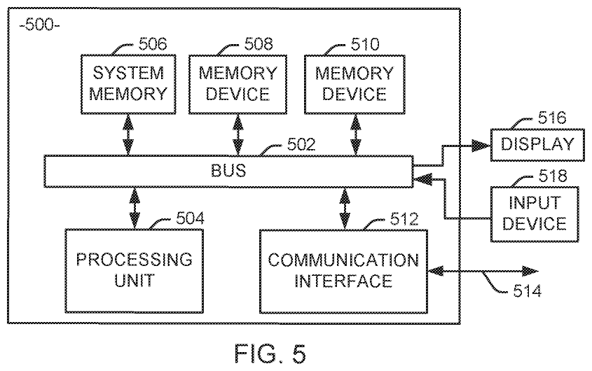

FIG. 5 is a schematic block diagram illustrating an example system 500 of hardware components capable of implementing examples of the systems and methods disclosed herein. The system 500 can include various systems and subsystems. The system 500 can include one or more of a personal computer, a laptop computer, a mobile computing device, a workstation, a computer system, an appliance, an application-specific integrated circuit (ASIC), a server, a server BladeCenter, a server farm, etc.

The system 500 can include a system bus 502, a processing unit 504, a system memory 506, memory devices 508 and 510, a communication interface 512 (e.g., a network interface), a communication link 2214, a display 516 (e.g., a video screen), and an input device 518 (e.g., a keyboard, touch screen, and/or a mouse). The system bus 502 can be in communication with the processing unit 504 and the system memory 506. The additional memory devices 508 and 510, such as a hard disk drive, server, standalone database, or other non-volatile memory, can also be in communication with the system bus 502. The system bus 502 interconnects the processing unit 504, the memory devices 506 and 510, the communication interface 512, the display 516, and the input device 518. In some examples, the system bus 502 also interconnects an additional port (not shown), such as a universal serial bus (USB) port.

The processing unit 504 can be a computing device and can include an application-specific integrated circuit (ASIC). The processing unit 504 executes a set of instructions to implement the operations of examples disclosed herein. The processing unit can include a processing core.

The additional memory devices 506, 508, and 510 can store data, programs, instructions, database queries in text or compiled form, and any other information that may be needed to operate a computer. The memories 506, 508 and 510 can be implemented as computer-readable media (integrated or removable), such as a memory card, disk drive, compact disk (CD), or server accessible over a network. In certain examples, the memories 506, 508 and 510 can comprise text, images, video, and/or audio, portions of which can be available in formats comprehensible to human beings.

Additionally, or alternatively, the system 500 can access an external data source or query source through the communication interface 512, which can communicate with the system bus 502 and the communication link 514.

In operation, the system 500 can be used to implement one or more parts of a system in accordance with the present invention, such as the system 100 of FIG. 1 or the system 200 of FIG. 2. Computer executable logic for implementing the diagnostic system resides on one or more of the system memory 506, and the memory devices 508 and 510 in accordance with certain examples. The processing unit 504 executes one or more computer executable instructions originating from the system memory 506 and the memory devices 508 and 510. The term “computer readable medium” as used herein refers to a medium that participates in providing instructions to the processing unit 504 for execution. This medium may be distributed across multiple discrete assemblies all operatively connected to a common processor or set of related processors.

Specific details are given in the above description to provide a thorough understanding of the embodiments. However, it is understood that the embodiments can be practiced without these specific details. For example, physical components can be shown in block diagrams in order not to obscure the embodiments in unnecessary detail. In other instances, well-known circuits, processes, algorithms, structures, and techniques can be shown without unnecessary detail in order to avoid obscuring the embodiments.

Implementation of the techniques, blocks, steps, and means described above can be done in various ways. For example, these techniques, blocks, steps, and means can be implemented in hardware, software, or a combination thereof. For a hardware implementation, the processing units can be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments can be described as a process which is depicted as a flowchart, a flow diagram, a data flow diagram, a structure diagram, or a block diagram. Although a flowchart can describe the operations as a sequential process, many of the operations can be performed in parallel or concurrently. In addition, the order of the operations can be re-arranged. A process is terminated when its operations are completed but could have additional steps not included in the figure. A process can correspond to a method, a function, a procedure, a subroutine, a subprogram, etc. When a process corresponds to a function, its termination corresponds to a return of the function to the calling function or the main function.

Furthermore, embodiments can be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks can be stored in a machine-readable medium such as a storage medium. A code segment or machine-executable instruction can represent a procedure, a function, a subprogram, a program, a routine, a subroutine, a module, a software package, a script, a class, or any combination of instructions, data structures, and/or program statements. A code segment can be coupled to another code segment or a hardware circuit by passing and/or receiving information, data, arguments, parameters, and/or memory contents. Information, arguments, parameters, data, etc. can be passed, forwarded, or transmitted via any suitable means including memory sharing, message passing, ticket passing, network transmission, etc.

For a firmware and/or software implementation, the methodologies can be implemented with modules (e.g., procedures, functions, and so on) that perform the functions described herein. Any machine-readable medium tangibly embodying instructions can be used in implementing the methodologies described herein. For example, software codes can be stored in a memory. Memory can be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” can represent one or more memories for storing data, including read only memory (ROM), random access memory (RAM), magnetic RAM, core memory, magnetic disk storage mediums, optical storage mediums, flash memory devices and/or other machine-readable mediums for storing information. The term “machine-readable medium” includes but is not limited to portable or fixed storage devices, optical storage devices, wireless channels, and/or various other storage mediums capable of storing that contain or carry instruction(s) and/or data.

What have been described above are examples of the present invention. It is, of course, not possible to describe every conceivable combination of components or methodologies for purposes of describing the present invention, but one of ordinary skill in the art will recognize that many further combinations and permutations of the present invention are possible. While certain novel features of this invention shown and described below are pointed out in the annexed claims, the invention is not intended to be limited to the details specified, since a person of ordinary skill in the relevant art will understand that various omissions, modifications, substitutions and changes in the forms and details of the invention illustrated and in its operation may be made without departing in any way from the spirit of the present invention. Accordingly, the present invention is intended to embrace all such alterations, modifications, and variations that fall within the scope of the appended claims. As used herein, the term “includes” means includes but not limited to, the term “including” means including but not limited to. The term “based on” means based at least in part on. Additionally, where the disclosure or claims recite “a,” “an,” “a first,” or “another” element, or the equivalent thereof, it should be interpreted to include one or more than one such element, neither requiring nor excluding two or more such elements. No feature of the invention is critical or essential unless it is expressly stated as being “critical” or “essential.”

What is claimed is:

1. A method comprising:
receiving a first set of observations for the region of interest comprising, for each of a plurality of locations, a probability that a value associated with the location is consistent with a local background of the location and a second set of observations comprising, for each of the plurality of locations, a probability that the value associated with the location is not consistent with the local background of the location;
generating a first probability tensor representing probabilities for each of a plurality of states for each of the plurality of locations from the first set of observations and the second set of observations, a first state of the plurality of states representing the presence of a target at a location moving at a velocity within a range of velocities, and a second state of the plurality of states representing a state in which no target is present;
updating the first probability tensor according to a second probability tensor representing the probabilities for each of the plurality of states for each of the plurality of locations before receiving the first set of observations and the second set of observations to provide a posterior probability tensor representing probabilities for each of the plurality of states for each of the plurality of locations; and
determining that a target is present in the region of interest when the posterior probability associated with one of the plurality of states at one of the plurality of locations meets a threshold value.

2. The method of claim 1, further comprising normalizing the first probability tensor such that, for each of the plurality of locations within the region of interest, the sum of the probabilities across the plurality of states, including the first state and the second state, is equal to one.

3. The method of claim 1, further comprising iteratively repeating the following steps for a plurality of iterations, each of the plurality of iterations occurring at an associated one of a plurality of sequential time steps:
receiving a new set of observations for the region of interest comprising, for each of the plurality of locations, a probability that a value associated with the location is consistent with a local background of the location and a probability that the value associated with the location is not consistent with a local background of the location;
generating an initial probability tensor representing probabilities for each of the plurality of states for each of the plurality of locations from new set of observations;
updating the initial probability tensor according to a posterior probability tensor from a previous time step to provide a posterior probability tensor for a current time step representing probabilities for each of the plurality of states for each of the plurality of locations; and
determining that a target is present in the region of interest when a posterior probability for the current state and associated with one of the plurality of states at one of the plurality of locations meets the threshold value.

4. The method of claim 3, wherein an interval between a first time step of the plurality of sequential time steps and a second time step of the plurality of sequential time steps is different than an interval between the second time step of the plurality of sequential time steps and a third time step of the plurality of sequential time steps.

5. The method of claim 1, wherein generating the first probability tensor comprises applying at least one kinematic update matrix, each representing the motion of a target in a state associated with the kinematic update matrix, and a transition matrix that defines the likelihood that an object located in a given location of the plurality of locations will end up in a neighboring location of the plurality of locations based on a velocity resolution of the kinematic state, to each of the first set of observations and the second set of observations.

6. The method of claim 5, wherein the transition matrix is determined according to a Tranini function that provides an estimate for an object starting at a random point, x, within a location of the plurality of locations and moves at a random velocity within a velocity range, Δv, for the state associated with the kinematic update matrix for a known time, Δt, of the probability that the object ends up within a given location of the plurality of locations, wherein the Tranini function is defined as:
$$p ( x , Δ v , Δ t ) = min [ \frac{1 + Δ t Δ v}{2 Δ t Δ v} ( 1 - \frac{2 \vert x \vert}{1 + Δ t Δ v} ) , \frac{2}{1 + Δ t Δ v} , 1 ] .$$

7. The method of claim 1, wherein determining that the target is present in the region of interest when the posterior probability associated with the one of the plurality of states at one of the plurality of locations meets a threshold value comprises determining that the target is present when the posterior probability associated with the first state at one of the plurality of locations is not less than a threshold value or the posterior probability at one of the plurality of locations associated with the second state is not greater than a threshold value.

8. The method of claim 1, wherein receiving the first set of observations and the second set of observations for the region of interest comprises receiving an image of the region of interest and generating each of the first set of observations and the second set of observations from the image of the region of interest.

9. The method of claim 8, wherein the image of the region of interest is a radar image from a radar system.

10. The method of claim 8, wherein the image of the region of interest is a sonar image from a sonar system.

11. The method of claim 8, wherein the image of the region of interest is an image from a camera.

12. A system comprising:
a processor; and
a non-transitory computer readable medium storing machine-readable instructions executable by the processor to provide:
an observation interface that receives a first set of observations for the region of interest comprising, for each of a plurality of locations, a probability that a value associated with the location is consistent with a local background of the location and a second set of observations comprising, for each of the plurality of locations, a probability that the value associated with the location is not consistent with the local background of the location;
a recursive filter that detects and tracks objects within the region of interest, the recursive filter comprising:
a prediction component that generates a first probability tensor representing probabilities for each of a plurality of states for each of a plurality of locations associated with a region of interest from the first set of observations and the second set of observations, a first state of the plurality of states representing the presence of a target at a location moving at a velocity within a range of velocities, and a second state of the plurality of states representing a state in which no target is present; and
a filtering component that updates the first probability tensor according to a second probability tensor representing the probabilities for each of the plurality of states for each of the plurality of locations given at least one set of before receiving the first set of observations and the second set of observations to provide a posterior probability tensor representing probabilities for each of the plurality of states for each of the plurality of locations; and
a detection component that determines that a target is present in the region of interest when the posterior probability associated with one of the plurality of states at one of the plurality of locations meets a threshold value.

13. The system of claim 12, wherein the prediction component normalizes the first probability tensor such that, for each of the plurality of locations within the region of interest, the sum of the probabilities across the plurality of states is equal to one.

14. The system of claim 12, the prediction component applies at least one kinematic update matrix, each representing the motion of a target in a state associated with the kinematic update matrix, and a transition matrix that defines the likelihood that an object located in a given location of the plurality of locations will end up in a neighboring location of the plurality of locations based on a velocity resolution of the kinematic state, to each of the first set of observations and the second set of observations, the transition matrix being determined according to a Tranini function that provides an estimate for an object starting at a random point, x, within a location of the plurality of locations and moves at a random velocity within a velocity range, Δv, for the state associated with the kinematic update matrix for a known time, Δt, of the probability that the object ends up within a given location of the plurality of locations, wherein the Tranini function is defined as:
$$p ( x , Δ v , Δ t ) = min [ \frac{1 + Δ t Δ v}{2 Δ t Δ v} ( 1 - \frac{2 \vert x \vert}{1 + Δ t Δ v} ) , \frac{2}{1 + Δ t Δ v} , 1 ] .$$

15. The system of claim 12, wherein the detection component determines that the target is present when the posterior probability associated with the first state at one of the plurality of locations is not less than a threshold value or the posterior probability at one of the plurality of locations associated with the second state is not greater than a threshold value.

16. The system of claim 12, wherein the observation interface comprises:
an image interface that receives an image of the region of interest from an associated imaging system; and
a probability map generator that generates each of the first set of observations and the second set of observations from the image of the region of interest.

17. A method comprising:
receiving an image of a region of interest comprising a plurality of pixels;
generating, from the image of the region of interest, a first set of observations for the region of interest comprising, for each of the plurality of pixels, a probability that a value of the pixel is consistent with a local background of the pixel and a second set of observations comprising, for each of the plurality of pixels, a probability that the value of the pixel is not consistent with a local background of the pixel;
generating a first probability tensor representing probabilities for each of a plurality of states for each of a plurality of pixels associated with a region of interest from the first set of observations and the second set of observations, a first state of the plurality of states representing the presence of a target at a pixel moving at a velocity within a range of velocities, and a second state of the plurality of states representing a state in which no target is present;
normalizing the first probability tensor such that, for each of the plurality of pixels within the region of interest, the sum of the probabilities across the plurality of states is equal to one;
updating the first probability tensor according to a second probability tensor representing the probabilities for each of the plurality of states for each of the plurality of pixels given at least one set of before receiving the first set of observations and the second set of observations to provide a posterior probability tensor representing probabilities for each of the plurality of states for each of the plurality of pixels; and
determining that a target is present in the region of interest when the posterior probability associated with one of the plurality of states at one of the plurality of pixels meets a threshold value.

18. The method of claim 17, wherein generating the first probability tensor comprises applying at least one kinematic update matrix, each representing the motion of a target in a state associated with the kinematic update matrix, and a transition matrix that defines the likelihood that an object located in a given pixel of the plurality of pixels will end up in a neighboring pixel of the plurality of pixels based on a velocity resolution of the kinematic state, to each of the first set of observations and the second set of observations, wherein the transition matrix is determined according to a Tranini function that provides an estimate for an object starting at a random point, x, within a pixel of the plurality of pixels and moves at a random velocity within a velocity range, Δv, for the state associated with the kinematic update matrix for a known time, Δt, of the probability that the object ends up within a given pixel of the plurality of pixels, wherein the Tranini function is defined as:
$$p ( x , Δ v , Δ t ) = min [ \frac{1 + Δ t Δ v}{2 Δ t Δ v} ( 1 - \frac{2 \vert x \vert}{1 + Δ t Δ v} ) , \frac{2}{1 + Δ t Δ v} , 1 ] .$$

19. The method of claim 17, wherein determining that the target is present in the region of interest when the posterior probability associated with the one of the plurality of states at one of the plurality of pixels meets a threshold value comprises determining that the target is present when the posterior probability associated with the first state at one of the plurality of pixels is not less than a threshold value or the posterior probability at one of the plurality of pixels associated with the second state is not greater than a threshold value.

20. The method of claim 16, wherein each of receiving the image of the region of interest, generating the first set of observations, the second set of observations, and the first probability tensor, normalizing the first probability tensor, and updating the first probability tensor are repeated iteratively, with each iteration separated by an interval of time, wherein an interval of time between a first iteration and a second iteration is different that an interval of time between the second iteration and a third iteration.
